(19) United States
(12) Patent Application Publication
(10) Pub. No.: US 2011/0153347 A1
(43) Pub. Date: Jun. 23, 2011

(54) Analysis of User Laboratory Test Results

(76) Inventors: Adam Bosworth, San Francisco, CA (US); Robert Williams, San Francisco, CA (US)

(21) Appl. No.: 12/751,767

(22) Filed: Mar. 31, 2010

Related U.S. Application Data
(60) Provisional application No. 61/289,924, filed on Dec. 23, 2009.

(51) Int. Cl. G06Q 50/00

(52) U.S. Cl. 705/2

(57) ABSTRACT

Lab tests may be processed for a user through execution of a lab test coaching engine stored in memory and executable by a processor. The lab test coaching engine accesses user lab test results and processes the user lab test results based on a coaching protocol and user health data. The results of the lab test results are reported to the user and a health care professional and the lab test coaching engine may perform an action based processed lab test results.

### CROSS-REFERENCE TO RELATED APPLICATION

This application claims the priority benefit of U.S. provisional application No. 61/289,924, filed Dec. 23, 2009 and entitled “Analysis of User Lab Test Results.” The disclosure of the aforementioned application is incorporated herein by reference.

### BACKGROUND OF THE INVENTION

1. Field of the Invention

The present invention generally concerns user health assessment. More particularly, the present invention relates to processing and analyzing laboratory (“lab”) test results for a user.

2. Description of the Related Art

Monitoring various aspects of personal health is an important part of living a long and productive life. To that end, a variety of services are available to assist people in tracking different aspects of their health. For example, numerous web services, such as WebMD.com or Health.com, provide general health information to a user. These informational services provide articles, discussion forums, and other educational tools that allow users to search, retrieve, and review content of particular interest or applicability. For example, one existing web service might provide specific information for diabetes while another service might offer information regarding controlling blood pressure.

Other web services, such as JustAnswer.com, allow a user to submit a question to a practitioner with experience related to the subject matter of the question. The web service will then “post” or otherwise publish the answer to the user question after some period of time with or without a fee. These web services, however, do not consider any personal information about the user when addressing the question and may provide only broad-based and generalized information that is unlikely to be tailored to the requesting user. Further, the answer is posted by the web service for all to see and is thus not kept confidential between the user and the practitioner.

One aspect of user health that may require further information or explanation is lab test results. Lab test data can be complicated and particular to a user. There is a need in the art for a health service that analyzes and provides lab test information specific to a particular user. Such a service should offer ease of use not only for the end user but also for the entity providing or analyzing the lab test tailored for the particular user.

### SUMMARY OF THE CLAIMED INVENTION

In a first claimed embodiment, a method for processing a lab test for a user is claimed. Through the method, a processor accesses user lab test results and user health data, processes the lab test results based on a coach protocol and user health data, and reports the processed lab test results to the user. An action is then performed based on the processed user lab test results.

In a second claimed embodiment, a system for processing a lab test for a user is claimed. The system includes a data store to store lab test results and user health data and a lab test engine executable by a processor. Execution of the lab test engine by the processor accesses the user lab test results and user health data, processes the lab test results based on a coach protocol and the user health data, reports the processed lab test results to the user, and performs an action based on the processed user lab test results.

In a third claim embodiment, a computer-readable storage medium is claimed. The storage medium includes a computer program that is executable by a processor to perform a method for processing a lab test for a user. The method includes accessing user lab test results and user health data, processing the user lab test results based on a coach protocol and user health data, reporting the processed user lab test results to the user, and performing an action based on the processed user lab test results.

### BRIEF DESCRIPTION OF THE DRAWINGS

FIG. 1 is a system for authoring a protocol for analyzing and processing lab test data.

FIG. 2 illustrates a method for providing automated coaching.

FIG. 3 illustrates an interface for managing a health profile.

FIG. 4 illustrates an interface for providing lab results.

FIG. 5 illustrates alternative implementation of an interface for providing lab test results.

FIG. 6 illustrates an interface for providing details of lab test results.

FIG. 7 illustrates a computing system that may be used to implement an embodiment of the present invention.

### DETAILED DESCRIPTION

Lab tests assess different health factors and conditions and may differ by time, type, and specimen. One lab test, for example, may be designed for screening and prevention while another might be directed towards determining the presence and amount or absence of a specific substance. Given the potential complexity of lab test results and the impact the results could have on the patient, the lab test results, once processed or established, should ideally be presented to a patient in an easy-to-understand yet meaningful way.

In embodiments of the present invention, lab test data may be processed by a lab test engine to interpret and report lab test results to a user. A lab test engine executed within a health coaching engine may be configured for identifying and processing user health data. Following the analysis of user lab test results or receipt of updated user health data, the lab test engine may perform various actions such as providing a user associated with the test data with information, recommendations, alerts, and appointments with health care professionals.

The presently disclosed protocol authoring system and coaching engines are flexible in that they consider information from a variety of sources to process and interpret lab test results. The protocol may process both singularly occurring actions and those that occur repeatedly over time and that may be based on observed trends. Feedback regarding lab test results may be provided to a user based on the most recent user data as well as progress—good or bad—made by the user.

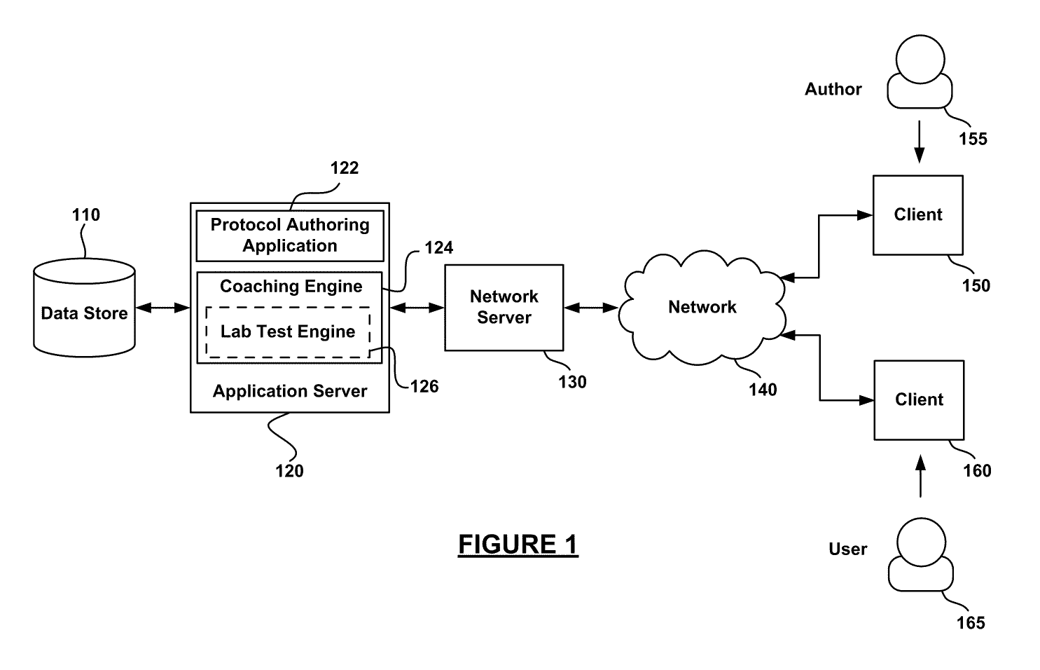

FIG. 1 is a system for authoring a protocol for processing user lab test data. The system of FIG. 1 includes data store 110, application server 120, network server 130, network 140, client (150, 160), author 155, and user 165.

Data store 110 stores user health data including attribute, range, protocol, goal, and other data. Data store 110 can be implemented as a logical data store on the same computing device as coaching engine 124, as one or more separate machines accessible by coaching engine 124, or a combination of the foregoing. The user health data may include current or past lab test results or data such as hemoglobin, high-density lipoprotein (HDL), low-density lipoprotein (LDL), or glucose levels, the date of lab test processing or specimen collection, and lab identification and/or location. User health data may also include user attributes (e.g. age, weight, birthday, gender, height), goals, ranges, rules, and vital signs (e.g. temperature, heart rate, pulse, respiratory rate, blood pressure). User health data may further include user lifestyle information (e.g. nutrition information, alcohol consumption, smoking habits), vaccinations, family history, medical history, allergies, surgical procedures, and any other data associated with user health.

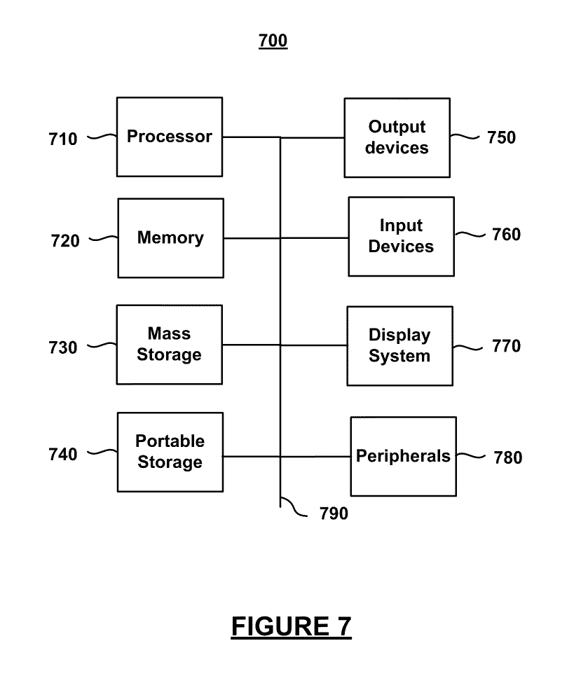

Application server 120 may be implemented in a general computing device that otherwise communicates with data store 110 and network server 130. An example of such a device is the general computing system illustrated in FIG. 7. Application server 120 as illustrated in FIG. 1 includes protocol authoring application 122 and coaching engine 124. Protocol authoring application 122 may by executed by a processor to provide interface data concerning a graphical interface to a client device (e.g., client 150). This interface data may then be executed and rendered as an interface by a client 150 application such as a web browser or Java Virtual Machine. The interface generated from the interface data can be used by author 155 at client 150 for authoring a protocol related to health coaching. The protocol authoring interface as generated from execution of the protocol authoring application 122 can include HTML, XML, scripts, or other code for rendering an authoring interface at client 150.

Coaching engine 124 is executable by a processor (not shown) at application server 120 to administer a user health coach protocol, where the administration includes generation and management of user attributes, goals, ranges, and rules. Attributes, goals, ranges and rules can be configured in response to input data received from an author 155 at client 150. Coaching engine 124 may be implemented as or may invoke a lab test engine 126, which executes on user health data (i.e. lab test data) to perform actions including analysis and interpretation of the data. The lab test engine 126 may be its own independent engine or integrated as a functional part of coaching engine 124.

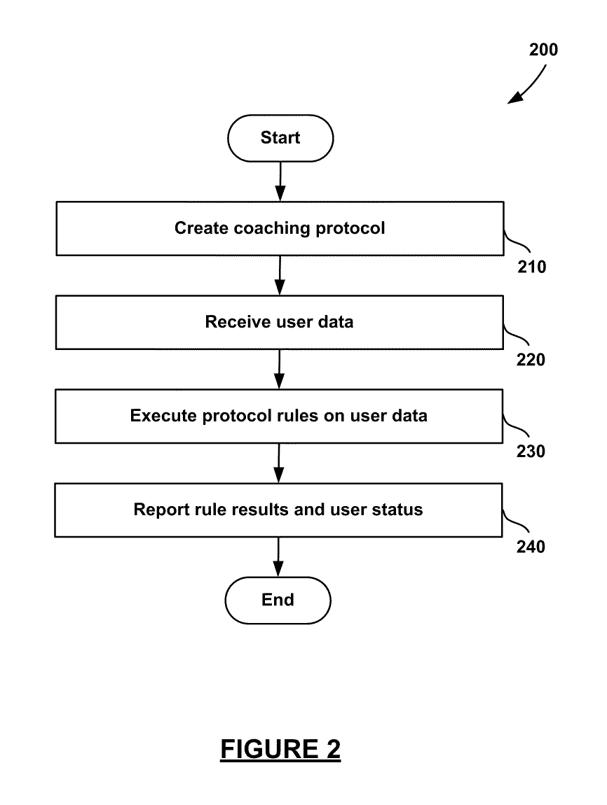

Protocol authoring application 122 is executed at the application server 120 to access, process, and transmit interface data to client 150 via network server 130 and network 140. The client 150 receives the interface data over network 140 and renders an interface from the interface data in a browser application or other client application, which provides the interface to an author 155. The client 150 may then receive input from an author 155 and transmit input data based on the input to coaching engine 124 and/or lab test engine 126 on application server 120 or data store 110 over network 140 and network server 130. The input data can include the received input, or data identifying the input, as well as routing information for data packets intended for coaching engine 124 and/or lab test engine 126. Details of setting attributes, goals, ranges and rules are discussed in more detail below with respect to FIG. 2.

Coaching engine 124, which may include the functionality of lab test engine 126, may access user health data and user lab test results from data store 110. The user health data and user lab test results may be retrieved and used to populate one or more interfaces. Data received as input by a client 150 may be transmitted to coaching engine 124 and/or lab test engine 126 and stored in data store 110. Coaching engine 124 may process user health data including user lab test results to provide alerts, notifications, suggestions, updated goals, status, calculated attributes, and other content to a user 165. The content can be provided to a user 165 through a coaching interface provided through client 160.

User 165 at client 160 may perform a login with a service provided by coaching engine 124 and receive interface data as a browser application content page. The interface data may include any updates for the user health status, including updated user goals, attribute values, and results of executed rule expressions.

Network 140 is inclusive of any communication network such as the Internet, Wide Area Network (WAN), Local Area Network (LAN), intranet, extranet, private network, or other network. Application server 120 may be accessed via network server 130. Network server 130 can receive and process requests from clients 150-160. Processing the requests may include sending a request to coaching engine 124 on application server 120, receiving a response from coaching engine 124, or forwarding that response to a requesting client.

Clients 150 and 160 are inclusive of a general purpose computing device capable of accessing information over a network like that illustrated in FIG. 7. Client 150, specifically, can generate the input data based on input received from author 155. Input data may be received at the client 150 through an interface generated from interface data received from execution of the protocol authoring application 122 over network 140. Input data may also be received at the client 160 based on input received from user 165.

Clients 150 and 160 may be implemented as computing devices such as workstations, servers, lap top computers, mobile devices, or other computing devices that can communicate over network 140. Client 150 may include a browser application for rendering coach protocol authoring interface data as a web page interface. Client 160 may include a browser application for rendering coach interface data as web pages interfaces for accessing a user health profile, user health updates and other content.

FIG. 2 illustrates a method 200 for providing automated health coaching. Coaching engine 124 and its corresponding lab test engine 126 functionality can be implemented as software stored in memory on application server 120 and executed by a processor to perform the method of FIG. 2. As illustrated in FIG. 2, a coaching protocol is created at step 210. The protocol may be generated based on protocol author 155 input received through one or more interfaces derived or rendered from protocol authoring interfaces rendered at client 150. Protocol authoring application 122 transmits interface data to be rendered as an interface at client 150. An author 155 provides input to client 150 through the rendered interface and the client 150 transmits input data to coaching engine 124 via network 140 and network server 130.

Creating a coaching protocol may include setting user ranges, attributes, goals and rules authored by a protocol author 155. A protocol author 155 may set one or more ranges for one or more user attribute values. A range, for example, may be created for hemoglobin A1c indicating that a value over 7% is labeled as “mildly elevated.” As another example, the protocol author 155 may create a user body mass index (BMI) range to be normal if “18.5-24.9,” “overweight” if 25-29.9 and “obese” if 30 or greater. Any created coaching protocol, range, or rule is stored in data store 110.

User attributes may include simple attributes or calculated attributes. Simple attributes may be provided by a user or some other source such as a health practitioner or medical facility and stored in data store 110 as they are received. Lab test engine 126 may calculate a calculated attribute by using or deriving from a simple attribute, another calculated attribute, user health data, and/or other data. For example, a simple attribute may be user weight, user height, red blood cell count, or hemoglobin information. A calculated attribute may be user BMI, which is a ratio calculated using the user weight in pounds multiplied by a constant and divided by the square of the user height in inches.

Lab test engine 126 may evaluate lab test results of a user over time. Lab test engine 126 may execute a coaching protocol that employs a trend function operation. A trend function operation evaluates user lab test results to identify a trend of an attribute value over time. A trend function operation may track, evaluate, and determine how a particular attribute value has changed over time such as if the attribute value has increased or decreased over time or has surpassed a particular value a certain number of times over a time period. The trend function may also determine whether an attribute value has experienced a particular rate of increase or decrease over time, or some other attribute trend. For example, a trend function may determine if a user experiences an abnormal fluctuation of hemoglobin level attribute or blood glucose level attribute over a period of time.

A coaching protocol executed by lab engine 126 may also automatically set or create a user health goal for any number of user attributes. Alternatively, a user health goal may be set manually by a user or health care professional. A health goal can specify an attribute, time, description, timeline, and/or other data relating to the goal and may be based on the user health data including the user lab test results. Goal input received from a protocol author 155 can be transmitted by client 150 to protocol authoring application 122 or coaching engine 124/lab test engine 126, which can store the goal data locally or remotely at data store 110. For example, if processing or analysis of the user lab test reveals that the user has a mildly elevated blood glucose level, a health goal may automatically be generated for the user to start and adhere to a particular diet and fitness plan over a three month period.

A coaching protocol may be based on a user rule that can include an expression for evaluation, an action to be taken based on the outcome of the evaluation, and timing or periodicity data indicating when the rule should be evaluated. Evaluation of a rule can result in an action to take with respect to one or more users. An author 155 can configure a rule action to be, for example, a notification, instructions to take a lab test, instructions to exercise, instructions to consult a particular health care provider, enroll in a diet program, fill out a questionnaire, improve a value, or some other action. Rule periodicity information indicates how often a rule action should be performed. An example of a method for creating a coaching protocol is discussed in U.S. patent application Ser. No. 12/360,731, filed Jan. 27, 2009, and entitled “Protocol Authoring for a Health Coaching Service,” the content of which is incorporated herein by reference.

After creating the coaching protocol at step 210 in FIG. 2, user health data may be received at step 220. The received data may include user lab test results, user data (e.g. demographic information, attribute values, past medical history, family history, vaccinations, social history, procedures, allergies), and any other user health data. The user health data may be received through user lab test results, data provided by health practitioners or medical facilities, questionnaires provided by the health coach service, protocol author 155 input through client 150, user input through client 160, or other sources.

Protocol rules can be executed with respect to the user health data according to the coaching protocol at step 230. The protocol rules are executed by coaching engine 124 according to the authored protocol. Protocol rules can be executed through execution of one or more coaches periodically (e.g. daily, weekly, twice per day), based on a previous action, or in response to some other event such as the receipt of new or updated user data from the user, a health practitioner or some other medical facility. Coaches may be executed for a user at least once a day.

Executing protocol rules includes retrieving a health service user list by coaching engine 124. The health service user list can be stored on application server 120 or data store 110 and includes a list of users participating in the health service. Coaching engine 124 can then retrieve a coach list for each user in the user list. The coach list can be retrieved from application server 120 or data store 110 and includes a list of coaches (e.g., executable coach objects) to execute for each particular user. Each coach list may include an executable root coach for the user and may contain one or more additional executable coaches. As the root coach is executed, the root coach may enroll the user in additional coaches (e.g., the root coach software may add additional coach objects to the coach list of the user) such as a lab test coach as implemented through lab test engine 126.

The one or more coaches listed in a user coach list are selected by coaching engine 124 to be executed by a processor. Coaching engine 124 can first execute a root coach for a user, followed by execution of additional coaches in the order the coaches were added to the user coach list.

Each coach instance, or coach, can retrieve rules and actions. The rules can include an expression with one or more attributes and be retrieved by a coach instance from application server 120 or from data store 110. Actions can also be retrieved from application server 120 or data store 110. The retrieved rules are then executed by the coach instance to determine if an action should be performed based on an attribute value or an identified trend function. A rule, for example, may perform an action of enrolling a user in a diet program if the user BMI has surpassed a threshold value over a period of time.

Once a coach instance is created and the coach rule is evaluated, a determination may be made as to whether the expression is evaluated to be true. If a rule expression for a coach is evaluated to be true, the coach instance containing the expression determines the last time the action corresponding to the expression was performed. Coaching engine 124 may query a user action log on application server 120 or data store 110 for the most recent entry for the particular action.

For expressions evaluated to be true, the date the corresponding action was last performed is compared to a periodicity period for the expression by the coaching instance. If the time period between the last performance of the action and the current time is less than the periodicity period, the action is not performed. If the time period since the last time the action was performed is greater than the periodicity period, the action corresponding to the evaluated expression can be performed by the coach instance. An example of a method for executing a protocol by a coaching engine is discussed in U.S. patent application Ser. No. 12/434,574, filed May 1, 2009 and entitled “Coaching Engine for a Health Coaching Service,” the content of which is incorporated herein by reference.

Lab test engine 126 may execute protocol rules on user health data to identify potential health risks for the user. For example, lab test engine 126 may be executed to evaluate a rule that identifies the risk of heart disease for a user. Lab test engine 126 may execute protocol rules on user data (e.g. user age, family history of heart disease, smoking habits, cholesterol, blood pressure, BMI, diabetes, stress, and alcohol consumption) to identify whether the user is at risk for heart disease. Lab test engine 126 may also consider lab test results in determining a particular health risk. The identified health risk may be reported to the user in the form of a percentage, score, comparison or any other format. For example, the lab test engine 126 may generate a report or notification indicating that that user, considering his family history, medical history, and eating habits, has a 65% chance of developing heart disease, or is two times more likely than an average 45 year old man to develop heart disease.

Lab test engine 126 may apply a rule to a user attribute to determine if the user attribute may contribute to a health risk and whether a corresponding action should be triggered. For example, if a user smokes and has high blood pressure, an action may be performed to send an alert to the user, or provide the user with information on how to stop smoking and set up an appointment between the user and a health provider for an examination. Another action may include setting a goal for the user, such as a goal of exercising at least 30 minutes per day for four days a week, thereby contributing to losing weight and reducing blood pressure.

Returning to the method of FIG. 2, after executing protocol rules for a coach instance, one or more actions may be performed and the action results and user status are reported at step 240. The coaching engine 124 may report the processed lab results and/or user health status to the user at an interface of client 160. Alternatively or in addition, the processed lab results of the user and/or user health status may be reported to the attending physician for the user, other health care professional, or medical facility through an interface of a client device. Lab test engine 126 may generate an alert or notification via e-mail or text message, or post alert or notification within a content page interface provided by the health coach service to report lab test results and user health status to the user. Other performed actions may include requesting the user to provide additional information about the health status of the user, providing information to the user about a health condition of the user, or enrolling the user into a coach or program (e.g. diet or fitness program).

The action for an expression evaluated to be true is automatically performed or “fired” if the time period has expired since the last time the action was performed. A rule action may also include providing a user notification (i.e. via e-mail and/or text message). The user notification may include an alert, warning, recommendation, or instruction. The user notification may include, for example, instructing the user to submit to another lab test, recommending that the user consult a health care provider, requesting the user to provide additional information about the current or past health status or condition of the user, requesting the user to fill out a questionnaire, or improve an attribute value (e.g., weight, BMI, cholesterol levels), or some other action. A user notification may be provided when a user has failed to perform a particular action, an attribute value has exceeded a threshold, more information is required from the user, or some other event has been detected. A rule action can be tagged with content such as a blog, pod cast, video, audio, image, or some other data. When the rule is executed, the content can be forwarded to the user as part of the performed action if the conditions for the rule have been met.

For a questionnaire, the coach instance may invoke a questionnaire engine to provide the questionnaire to the user. The questionnaire engine may retrieve questions from a questionnaire library stored in data store 110, construct the questionnaire, and provide the questionnaire to the user, such as through a coach service web page (not shown). Alternatively, an action can be fired manually as a result of an author input at client 150 or user input at client 160. For example, a doctor may receive a user health status report indicating that the user prefers to limit sun exposure and that the user lab tests results reveal elevated levels of LDL and high blood pressure. Given this information, the doctor may use coaching engine 124 to executing a coaching protocol for sending the user a recommendation consisting of a particular diet plan and 30-minute daily exercise routines that can be performed indoors.

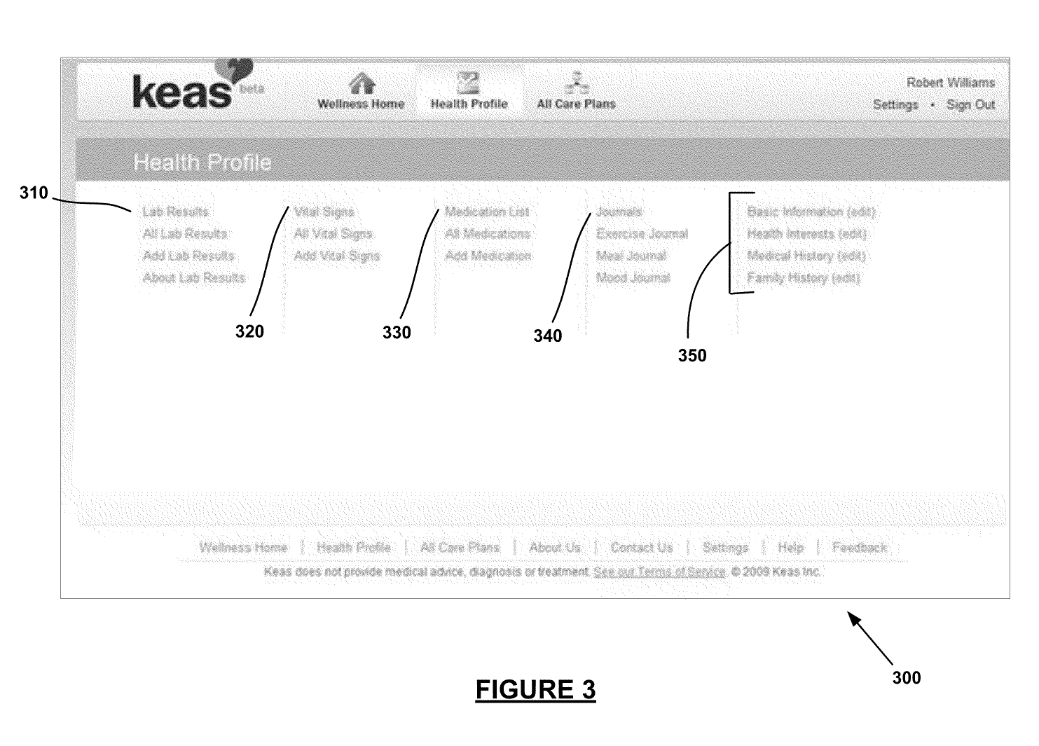

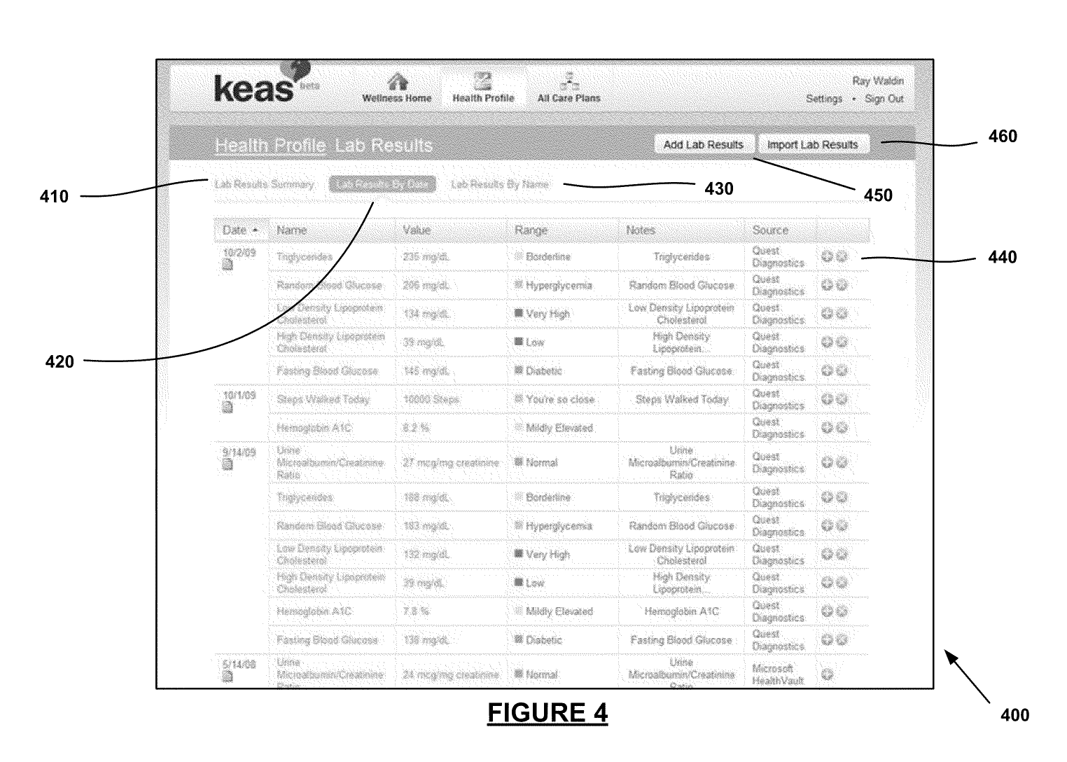

FIG. 3 illustrates an interface for managing a user health profile. The interface 300 of FIG. 3 provides a number of selectable interface indicators that provide more information about a patient (user) health profile when selected. Some of the selectable indicators include “Lab Results” 310, “Vital Signs” 320, “Medication List” 330, “Journals” 340, “Basic Medical Information,” “Health Interests,” “Medical History,” and “Family History” 350. Under “Lab Results” 310, a user may view all lab results by selecting “All Lab Results” as discussed in FIG. 4 and a user, the doctor of a user, other health care professional, or medical facility may add lab test results to a user profile by selecting “Add Lab Results.”

By selecting the “Vital Signs” indicator 320, a user may view current or most recent vital signs, or view a listing of all vital signs over a period of time (by selecting “All Vital Signs”). Similarly, the vital signs of a user may be added using the “Add Vital Signs” indicator. Using the “Medication List” indicator 330, a user may view a current medication list, or a list of all current and past medications by selecting “All Medications.” A user may also update the medication list by selecting “Add Medication.” A user may also view and edit the health profile at any time by selecting “Basic Information,” “Health Interests,” “Medical History,” or “Family History” and updating (e.g. adding, deleting) the health profile with new information.

FIG. 4 illustrates an interface 400 for providing lab results. The interface 400 may provide a summary of lab results 410. Lab results may be sorted by date or name by selecting the “Lab Results by Date” button 420 or “Lab Results By Name” button 430, respectively. When providing lab results by date, lab results are grouped by date and listed in the interface, as shown in the interface 400 of FIG. 4. For a particular date, the name of an identified substance is listed along with a value, range, applicable notes and source. For example, in row 440, lab test results provided by “Quest Diagnostics” show Triglycerides with a value of 235 mg/dL to be in a “Borderline” range for the user. A user, doctor of a user, or other health care professional may add other lab results to the user health profile by selecting the “Add Lab Results” button 450 or “Import Lab Results” 460.

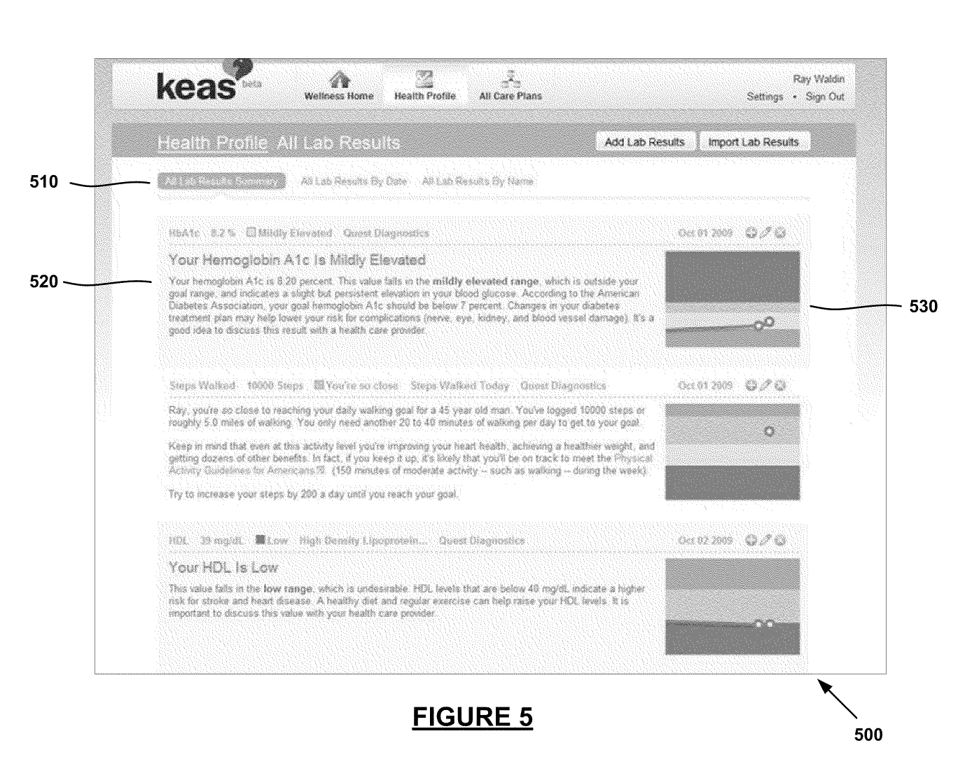

FIG. 5 illustrates an alternative implementation of an interface for providing lab test results. The interface 500 may be configured to provide “All Lab Results” information, per the selectable indicator 310 in the interface of FIG. 3. The interface 500 of FIG. 5 may provide a summary of all lab results, all lab results by date, or all lab results by name per the configuration menu 510. An overall summary of all lab tests performed may be presented. Alternatively or in addition, a summary or explanation of each substance tested 520 on a particular date along with its value, range, and source may be presented within the interface 500 as illustrated in FIG. 5.

Interface 500 may also include other content in the form of text, video, graphics relating to the interpretation and explanation of the lab test results. Interface 500 may include a graphical representation of the lab test results 530 showing how the current lab test results for the user compare to previous lab test results (e.g. the presence of a trend) or how all lab test results fall within a range. Interface 500 may also display other information for the user such as recommendations for healthy living and diet based on the user lab test results and user health data.

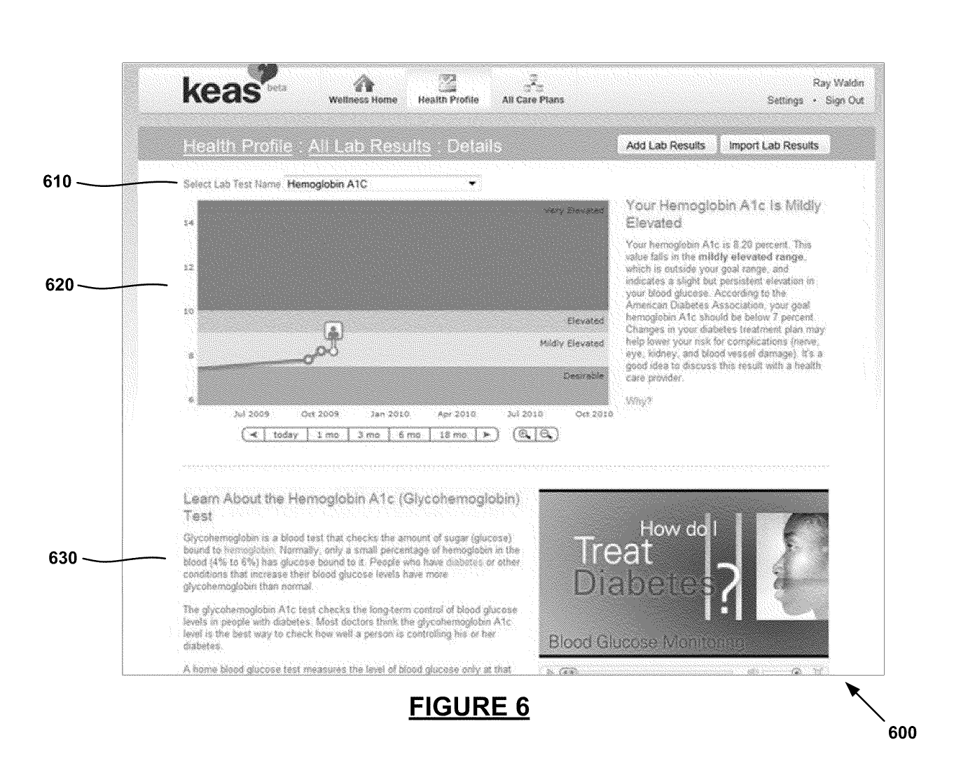

FIG. 6 illustrates an interface 600 for providing details of lab test results. The interface 600 may provide details for a particular lab test result, per a drop-down menu 610. A user may select a lab test result from the drop-down menu and receive further explanation. Lab test details may include a graphical representation of the progress of an attribute value associated with the lab test 620, range information for the attribute value, interpretation of the lab test results, and additional information about the lab test that explains the lab test and results in easy to understand terms 630.

A graphical representation of the user lab test results can track the results and show how the results have changed over a period of time (e.g., weekly, monthly, yearly). The graphical representation may also show how a lab test result falls into a certain range such as if the test result is “Desirable,” “Mildly Elevated,” “Elevated,” or “Very Elevated.” Interface 600 may also include other details 630 about the lab test results. A user may be presented with more information about the particular lab test such as how or why a particular lab test is administered or what substance is being analyzed.

FIG. 7 illustrates an exemplary computing system 700 that may be used to implement an embodiment of the present invention. System 700 of FIG. 7 may be implemented in the contexts of the likes of data store 110, application server 120, network server 130, protocol authoring application 122, and clients 150-160. The computing system 700 of FIG. 7 includes one or more processors 710 and memory 720. Main memory 720 stores, in part, instructions and data for execution by processor 710. Main memory 720 can store the executable code when in operation. Main memory 720 may also store data store 110. The system 700 of FIG. 7 further includes a mass storage device 730, portable storage medium drive(s) 740, output devices 750, user input devices 760, a graphics display system 770, and peripheral devices 780.

The components shown in FIG. 7 are depicted as being connected via a single bus 790. However, the components may be connected through one or more data transport means. For example, processor unit 710 and main memory 720 may be connected via a local microprocessor bus, and the mass storage device 730, peripheral device(s) 780, portable storage device 740, and graphics display system 770 may be connected via one or more input/output (I/O) buses.

Mass storage device 730, which may be implemented with a magnetic disk drive or an optical disk drive, is a non-volatile storage device for storing data and instructions for use by processor unit 710. Mass storage device 730 can store the system software for implementing embodiments of the present invention for purposes of loading that software into main memory 710.

Portable storage device 740 operates in conjunction with a portable non-volatile storage medium, such as a floppy disk, compact disk or Digital video disc, to input and output data and code to and from the computer system 700 of FIG. 7. The system software for implementing embodiments of the present invention may be stored on such a portable medium and input to the computer system 700 via the portable storage device 740.

Input devices 760 provide a portion of a user interface. Input devices 760 may include an alpha-numeric keypad, such as a keyboard, for inputting alpha-numeric and other information, or a pointing device, such as a mouse, a trackball, stylus, or cursor direction keys. Additionally, the system 700 as shown in FIG. 7 includes output devices 750. Examples of suitable output devices include speakers, printers, network interfaces, and monitors.

Display system 770 may include a liquid crystal display (LCD) or other suitable display device. Display system 770 receives textual and graphical information, and processes the information for output to the display device.

Peripherals 780 may include any type of computer support device to add additional functionality to the computer system. For example, peripheral device(s) 780 may include a modem or a router.

The components contained in the computer system 700 of FIG. 7 are those typically found in computer systems that may be suitable for use with embodiments of the present invention and are intended to represent a broad category of such computer components that are well known in the art. Thus, the computer system 700 of FIG. 7 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Palm OS, and other suitable operating systems.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

What is claimed is:

1. A method for processing a lab test for a user, comprising:
executing instructions stored in memory, wherein execution of the instructions by a processor:
accesses user lab test results,
accesses user health data,
processes the user lab test results based on a coach protocol and the user health data,
reports the processed user lab test results to the user, and
performs an action based on the processed user lab test results.

2. The method of claim 1, wherein the action includes sending a notification to the user.

3. The method of claim 1, wherein the action includes instructing the user to submit to another lab test.

4. The method of claim 1, wherein the action includes requesting the user to provide additional information about the health status of the user.

5. The method of claim 1, wherein the action includes enrolling the user in an additional coach.

6. The method of claim 1, wherein the action includes enrolling the user into a dietary or fitness program.

7. The method of claim 1, wherein the action includes providing the user with health information about a health condition of the user.

8. The method of claim 1, wherein the action includes identifying a health risk associated with the user based on the processed lab test results.

9. The method of claim 1, wherein the action includes setting a health goal for the user.

10. The method of claim 1, further comprising storing the processed user lab test results.

11. The method of claim 1, wherein the coach protocol includes a trend function that evaluates an attribute value over time.

12. A system for processing a lab test for a user, comprising:
a data store to store user lab test results and user health data; and
a lab test engine stored in memory and executable by a processor to:
access user lab test results,
access user health data,
process the user lab test results based on a coach protocol and the user health data,
report the processed user lab test results to the user, and
perform an action based on the processed user lab test results.

13. The system in claim 12, wherein the lab test engine evaluates user lab test results over time.

14. The system in claim 12, wherein the lab test engine identifies a trend function based on user lab test results.

15. The system in claim 12, wherein the lab test engine calculates a user attribute value based on the user health data.

16. The system in claim 12, wherein the lab test engine generates a notification for the user.

17. The system in claim 12, wherein the lab test engine determines a health risk associated with the user based on the processed lab test results.

18. The system in claim 12, wherein the lab test engine creates a health goal for the user.

19. The system in claim 12, wherein the processed lab test results are stored in the data store.

20. A computer-readable storage medium having embodied thereon a program, the program being executable by a processor to perform a method for processing a lab test for a user, the method comprising:
accessing user lab test results,
accessing user health data,
processing the user lab test results based on a coach protocol and the user health data,
reporting the processed user lab test results to the user, and
performing an action based on the processed user lab test results.
